(19) United States
(12) Patent Application Publication
(10) Pub. No.: US 2025/0326212 A1
(43) Pub. Date: Oct. 23, 2025

(54) MULTILAYER PACKAGING FILM

(71) Applicant: Amcor Flexibles North America, Inc., Neenah, WI (US)

(72) Inventors: Steven M. Grey, Oshkosh, WI (US); Kevin P. Nelson, Appleton, WI (US); Daniel C. Miller, Appleton, WI (US); Jeremy C. Reedy, Appleton, WI (US); Jingxing Feng, Chicago, WI (US)

(21) Appl. No.: 18/860,582

(22) PCT Filed: Apr. 29, 2022
(86) PCT No.: PCT/US2022/027054

§ 371 Date: Oct. 25, 2024

(51) Int. Cl. B32B 27/08; B32B 7/02; B32B 27/16; B32B 27/30; B32B 27/32; B32B 37/24; B32B 38/00; B65D 65/40

(52) U.S. Cl. CPC B32B 27/08; B32B 7/02; B32B 27/16; B32B 27/306; B32B 27/32; B32B 37/24; B32B 38/164; B65D 65/40; B32B 2037/243; B32B 2250/02; B32B 2250/246; B32B 2255/10; B32B 2255/26; B32B 2307/7166; B32B 2307/72; B32B 2307/748; B32B 2439/02; B32B 2439/46; B32B 2439/70; B32B 2439/80

(57) ABSTRACT

A multilayer packaging film includes a first film, a second film, and a primer layer. The primer layer includes a water dispersible material. The first film includes a first polymer. The second film includes a barrier layer including a barrier material. The primer layer is positioned between a first film second surface and a second film first surface.

### TECHNICAL FIELD

This disclosure is related to multilayer packaging films, thermoformable films, recyclable films, and rigid packaging components made therefrom. The multilayer packaging films, thermoformable films, recyclable films, and rigid packaging components may be recyclable.

### BACKGROUND

Multilayer packaging films can be used to form flexible or thermoformed packages. Thermoformed packages include thermoformed containers that are often used as packaging components for consumer, industrial, or medical products. These packages often contain products that are sensitive to their environment (e.g., food, beverages, liquids, pharmaceuticals, etc.) such that the packaging helps protect the product and extend the shelf-life to a point in time where a consumer can use the product. Many products that are sensitive to their environment include a moisture content from 30% to 100% by weight of the product.

Common polymers used for flexible packaging and thermoforming include polystyrene (PS), polyvinyl chloride (PVC), polypropylene (PP), or polyester. For some products, some of these polymers provide acceptable barrier for the product contained in the package. For other polymers, such as polyester or PS, the resulting films and packaging components often include additional polymers or additives that are chosen to enhance moisture barrier or oxygen barrier of the packaging for the contained product.

Global demand for plastic waste reduction and sustainable packaging solutions is on the rise. For example, thermoformed packaging components, such as cups or trays, often cannot be recycled due to the component including a variety of polymers that provide barrier to prevent the ingress of oxygen and/or moisture into the package.

Recycling is often efficient or may only be possible if the materials in the package are of the same polymer. For example, in many countries, there are current processes in place to collect, sort and recycle packages of a single polymer, for example, HDPE, polyester, or PP. However, the combination of materials in a packaging film or component (e.g., polyester or PP with additional polymers or additives to enhance barrier) can create difficulties when determining how to dispose of the packaging component after use. Further, some of the current processes in place to recover and recycle packaging components restrict the size and volume of the packaging component. In some recycling processes, a packaging component volume larger than 7.5 liters (2 gallons) or a packaging component size smaller than 5 centimeters (cm) (2 inches (in)) in 2 dimensions is not acceptable. For example, a packaging component in the form of a liquid creamer cup (e.g., coffee creamer cup, liquid creamer singles, coffee creamer singles) that measures less than 5 cm in each of 2 dimensions cannot be recycled by most current processes whether it is composed of a single polymer or a combination of polymers.

### SUMMARY

This disclosure relates to multilayer packaging films, thermoformable films, recyclable films, and thermoformed components (e.g., packaging component), Thermoformed components may include cups or trays formed from the films. The films and thermoformed components can be used for packaging a wide variety of products including, but not restricted to food, cosmetics, lotions, lawn care products, cleaners/soaps, concentrates, industrial materials, pharmaceuticals, medical supplies, and medical devices. Some films and thermoformed components may not be recyclable due to the thermoformed component size or volume or due to polymer combinations that do not lend themselves to recovery and recycling processes.

The films and thermoformed components of this disclosure include polymer combinations that may be recovered regardless of volume or size, for example, in a wash-sink-float-separation process (e.g., hot wash process, warm water wash process, caustic wash process) and further recycled.

In a first embodiment, a multilayer packaging film has a first surface and a second surface. The multilayer packaging film comprises a primer layer, a first film, and a second film. The primer layer comprises a coating comprising a water dispersible material. The first film is connected to the primer layer. The first film comprises a first polymer and has a first surface and a second surface. The second film is connected to the primer layer. The second film comprises a barrier layer comprising a barrier material and has a first surface and a second surface. The primer layer is positioned between the first film second surface and the second film first surface.

In a second embodiment, a method of making a multilayer packaging film having a first surface and a second surface includes the operations of forming, coating, drying, and laminating. For a forming operation, in one or more embodiments, a first film is formed comprising a first polymer and having a first surface and a second surface. For a subsequent forming operation, in one or more embodiments, a second film is formed comprising a barrier layer comprising a barrier material and having a first surface and a second surface. For a coating operation, in one or more embodiments, the first film second surface, the second film first surface, or a combination thereof, is coated with a water dispersible coating comprising a water dispersible material in a range of from 1% to 50% by weight of the water dispersible coating in a wet state. For a drying operation, in one or more embodiments, the water dispersible coating is dried from the wet state to form a primer layer, the primer layer connecting to the first film second surface, the second film first surface, or a combination thereof, respective to the coating operation. For a laminating operation, in one or more embodiments, the first film is laminated to the second film and the primer layer being positioned between the first film and the second film. The primer layer comprises a thickness comprising a range of from greater than 0% to 20% of the thickness of the multilayer packaging film.

In a third embodiment, a method of making a multilayer packaging film having a first surface and a second surface includes the operations of forming, coating, drying, and laminating. For a forming operation, in one or more embodiments, a second film is formed comprising a barrier layer comprising a barrier material and having a first surface and a second surface. For a coating operation, in one or more embodiments, the second film first surface is coated with a water dispersible coating comprising a water dispersible material in a range of from 1% to 50% by weight of the water dispersible coating in a wet state. For a drying operation, in one or more embodiments, the water dispersible coating is dried from the wet state to form a primer layer, the primer layer connecting to the second film first surface. For a subsequent forming operation, in one or more embodiments, a first film is formed comprising a first polymer and having a first surface and a second surface. The first film is formed by extrusion coating the first film second surface to connect with the primer layer. The primer layer comprises a thickness comprising a range of from greater than 0% to 20% of the thickness of the multilayer packaging film.

Other features that may be used individually or in combination with respect to any embodiment are as follows.

The first film, the second film, or both of the first film and the second film may be directly connected to the primer layer.

The first film first surface may form the multilayer packaging film first surface.

The second film second surface may form the multilayer packaging film second surface.

The multilayer packaging film may comprise an average bond strength of 20 grams/25.4 millimeters (g/25.4 mm) or greater between the first film second surface and the second film first surface according to ASTM F 904-98 (Reapproved 2003).

The water dispersible material may comprise an acidic moiety.

The water dispersible material may comprise a water dispersible sulfopolyester.

The primer layer may comprise a thickness in a range of from greater than 0% to 20% of the thickness of the multilayer packaging film.

The average density of the second film may be less than the average density of the first film.

The barrier material may comprise high density polyethylene (HDPE).

The barrier material may comprise ethylene vinyl alcohol copolymer (EVOH).

The first film may comprise an extrusion coated film.

The first film may comprise a multilayer film.

The second film may comprise a coextruded film.

The first film may comprise the first polymer comprising a single polymer in an amount in a range of from 90% to 100% of the single polymer by weight.

The multilayer packaging film may comprise an irradiated multilayer packaging film comprising a 20% or greater increase in average bond strength according to ASTM F 904-98 (Reapproved 2003).

In a fourth embodiment, a package comprising any of the multilayer packaging films disclosed herein.

### BRIEF DESCRIPTION OF THE DRAWINGS

The disclosure may be more completely understood in consideration of the following detailed description of various embodiments of the disclosure in connection with the accompanying drawings, in which:

FIG. 1 illustrates a schematic cross-sectional view of an embodiment of a multilayer packaging film;

FIG. 2 illustrates a schematic cross-sectional view of an embodiment of a multilayer packaging film;

FIG. 3 illustrates a schematic cross-sectional view of an embodiment of a multilayer packaging film;

FIG. 4 illustrates a schematic perspective view of an embodiment of a package formed from the multilayer packaging film;

FIG. 5 illustrates a schematic cross-sectional view of an embodiment of a package formed from the multilayer packaging film;

FIG. 6 illustrates a schematic perspective view of an embodiment of a thermoformed component;

FIG. 7 illustrates a schematic perspective view of an embodiment of a thermoformed component;

FIG. 8 illustrates a flowchart depicting method steps of making a multilayer packaging film in accordance with an embodiment of the present disclosure; and

FIG. 9 illustrates a flowchart depicting method steps of making a multilayer packaging film in accordance with an embodiment of the present disclosure.

The drawings show some but not all embodiments. The elements depicted in the drawings are illustrative and not necessarily to scale, and the same (or similar) reference numbers denote the same (or similar) features throughout the drawings.

### DETAILED DESCRIPTION

Described herein are multilayer packaging films that include thermoformable films, recyclable films, and thermoformed components made therefrom. The multilayer packaging film may be suitable for packaging products that might be sensitive to oxygen or moisture. Barrier materials may be included in the film and in component structures to prevent the ingress of oxygen and/or moisture. A lidding film may be heat sealed to a thermoformed component made from the multilayer packaging film, creating a package that contains a product. Suitable products may be, but are not limited to, fresh food, refrigerated foods, shelf-stable foods, pharmaceuticals, nutraceuticals, and non-food products, such as medical products, consumer goods, cosmetics, and chemicals. The product includes a moisture content from 0% to 100% by weight of the product. The term “moisture content”, as used herein, refers to the weight of the water contained in a product and is expressed as a percentage of the product weight. A moisture content of 0% indicates that the product is completely dry and a moisture content of 100% indicates that the product is completely saturated with liquid.

The packages described herein incorporate multilayer packaging films and may include packages that include at least two packaging components to contain products. One component may be a thermoformed component, formed from the multilayer packaging films described herein. The other component may be a lid component. The other component or lidding material is configured from a film or materials that are capable of being hermetically heat sealed to the thermoformed component, producing a protective package for the product. The lidding material may be combined with the thermoformed components in a variety of ways including, but not limited to, heat sealing, gluing, or welding.

The multilayer packaging films, thermoformable films, recyclable films, and thermoformed components can advantageously be processed to recover the polymers that may be recyclable without contamination from other packaging components or the barrier material polymers, for example. The multilayer packaging films, thermoformable films, recyclable films, and thermoformed components, for example, can be introduced into a separation process where a polymer (e.g., desired recovery polymer), such as a thermoformable polymer or recyclable single polymer, may be separated from the barrier material polymers or other packaging components. In some embodiments, the multilayer packaging films, thermoformable films, recyclable films, thermoformed components, and packaging components (e.g., lidding material) are recyclable in the same recycle process. In some embodiments, the packaging components, thermoformed components, recyclable films, thermoformable films, or multilayer packaging films may remain attached to a corresponding film or component such that the entire package may be recycled together without being separated from each other.

For example, a wash-sink-float separation process generally includes the multilayer packaging films, including thermoformable films, recyclable films, and thermoformed components, to be flaked or granulated (e.g., cut into small pieces) and washed in an aqueous detergent solution that allows the polymer and the barrier materials to be separated from each other. The flaked polymer can be recovered from the process and can be reused (e.g., recycled).

The multilayer packaging films, thermoformable films, recyclable films, and thermoformed components have the distinct advantage of recyclability in a single polymer recycling stream (e.g., polyester, polypropylene). This advantage is achieved while maintaining good barrier and package integrity.

### Multilayer Packaging Film

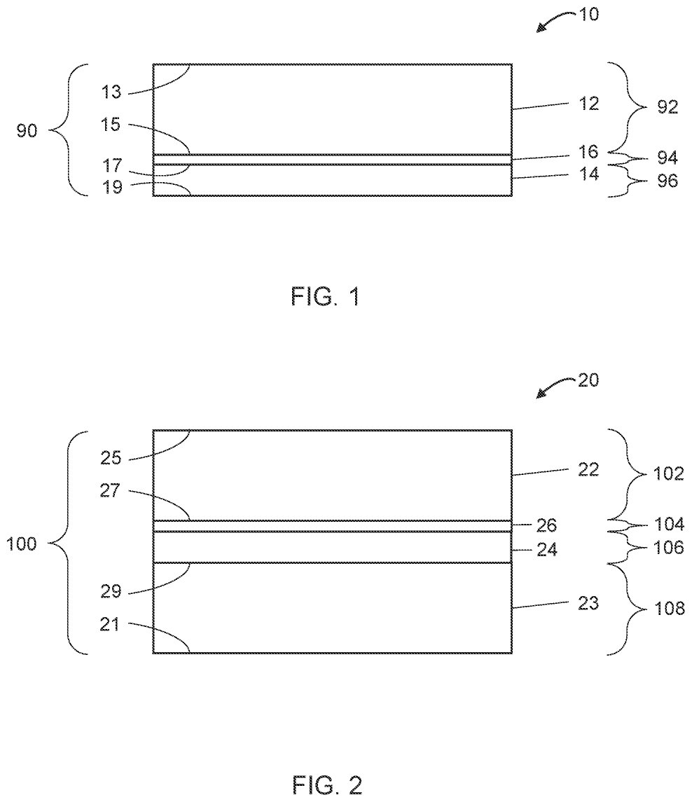

A multilayer packaging film 10, shown in FIG. 1, includes at least a first film 12, a primer layer 16, and a second film 14. The multilayer packaging film 10 includes the first film 12 that includes a first polymer. The second film 14 includes at least a barrier layer that includes a barrier material. The first film 12 includes a first surface 13 that includes a first surface of the multilayer packaging film 10 and a second surface 15 that opposes the first surface 13. The second film 14 includes a first surface 17 and a second surface 19 that opposes the first surface 17. The second surface 19 of second film 14 includes a second surface of the multilayer packaging film 10. The primer layer 16 is positioned between the second surface 15 of the first film 12 and the first surface 17 of the second film 14. The positioning and composition of the primer layer 16 allows the first film 12 to separate from the second film 14, for example, in a wash-sink-float separation process, such that the first polymer of the first film 12 and/or the barrier material of the second film 14 can be recovered and recycled. In an embodiment, the first polymer may be a thermoformable polymer. In an embodiment, the multilayer packaging film may be a thermoformable film. In an embodiment, the multilayer packaging film may be a recyclable film. In an embodiment, the first film includes a first surface of the multilayer packaging film. In an embodiment, the second film includes a second surface of the multilayer packaging film. In an embodiment, the first film includes the first surface of the multilayer packaging film and the second film includes the second surface of the multilayer packaging film.

The multilayer packaging film 10 includes a thickness 90. The first film 12 includes a first film thickness 92, the primer layer 94 includes a primer layer thickness 94, and the second film 14 includes a second film thickness 96. The primer layer thickness may be in a range of from greater than 0% to 20% of the thickness of the multilayer packaging film. In an embodiment, the primer layer thickness may be from 0.01% to 0.1%, 0.1% to 0.5%, 0.5% to 1%, 1% to 5%, 5% to 10%, 10% to 15%, 15% to 20%, or any range or combination of ranges therein of the multilayer packaging film.

The term “thermoformable polymer”, as used herein, refers to polymers that when heated above a minimum temperature will soften to a point where they can be physically formed into a desired shape, and when heated above a maximum temperature, the polymer cannot be web processed.

As used herein, the term “film” is a monolayer or multilayer web that has an insignificant z-direction dimension (thickness) as compared to the x- and y-direction dimensions (length and width). Films are generally regarded as having two major surfaces, opposite each other, expanding in the length and width directions. The surface of the film that is not connected to another layer or film is an exposed surface of the film. Films may be built from an unlimited number of films or layers, the films or layers being bonded together to form a multilayer film.

The term “layer”, as used herein, refers to a building block of films that is a structure of a single polymer or a homogeneous or heterogeneous blend of materials. A layer may contain other non-polymeric materials and may have additives. Layers may be continuous or discontinuous (i.e., patterned) with the length and width of the film. In a monolayer film, “film”, “sheet” and “layer” are synonymous.

The term “multilayer”, as used herein, refers to a single film structure, which may have a plurality of layers, generally in the form of a sheet or web that can be made from a polymeric material or a non-polymeric material bonded together by any conventional means known in the art, (i.e., coextrusion, lamination, coating, or a combination thereof).

The first film of the multilayer packaging film includes a first polymer. In some embodiments, the first polymer may include thermoformable functionality. Non-limiting examples of first polymers include polystyrene, polyester, polypropylene, polyethylene, polyamide, and blends thereof. Examples include, but are not limited to, high impact polystyrene (HIPS), polyethylene terephthalate (PET), amorphous polyethylene terephthalate (APET), crystalline polyethylene terephthalate (CPET), glycol-modified polyethylene terephthalate (PETG), polyethylene (PE) homopolymer, high density polyethylene (HDPE), polypropylene (PP) homopolymer, PP copolymer, and polycarbonate. In some embodiments, the thermoformable polymer is selected for its compatibility with a single polymer recycling stream or process. In some embodiments, the first polymer is selected for aesthetics, rigidity, thermoformability, or abuse resistance for a package resulting from the multilayer packaging film. In an embodiment, the first polymer includes a polypropylene. In another embodiment, the first polymer includes a polyester. In a further embodiment, the first polymer is a polyester.

The first polymer may include a melting point from 130° C. to 255° C. (266° F. to 491° F.) or any range or combination of ranges therein. In an embodiment, the first polymer may include a melting point from 130° C. to 225° C. (266° F. to 437° F.). In another embodiment, the first polymer includes a polyester and includes a melting point from 225° C. to 255° C. (437° F. to 491° F.). In other embodiments, the first polymer may be without a melting point, i.e., the first polymer may be amorphous because it is incapable of crystallizing (e.g., atactic polystyrene) or it is processed in a way that prevents substantial formation of crystals (e.g., APET).

As used throughout this application, the terms “polystyrene”, “PS”, or “styrenic based polymers” refer to a homopolymer or copolymer having at least one styrene monomer linkage (such as benzene (i.e., C₆H₆) having an ethylene substituent (i.e., phenyl group, C₆H₅) pendant to the repeating backbone of the polymer. The styrene linkage can be represented by the general formula: [CH₂—CH(C₆H₅)]ₙ.

As used throughout this application, the term “polyester” refers to a homopolymer or copolymer having an ester linkage between monomer units which may be formed, for example, by (a) condensation polymerization reactions between a dicarboxylic acid and a diol, (b) condensation reaction of hydroxy acids, or (c) ring opening of glycolide, lactide, (d) transesterification of a diol and a diester known as bis-HET, etc. The ester linkage can be represented by the general formula: [O—R—OC(O)—R′—C(O)]ₙ where R and R′ are the same or different alkyl (or aryl) group and may be generally formed from the polymerization of dicarboxylic acid and diol monomers containing both carboxylic acid and hydroxyl moieties. The dicarboxylic acid (including the carboxylic acid moieties) may be linear or aliphatic (e.g., lactic acid, oxalic acid, maleic acid, succinic acid, glutaric acid, adipic acid, pimelic acid, suberic acid, azelaic acid, sebacic acid, and the like) or may be aromatic or alkyl substituted aromatic (e.g., various isomers of phthalic acid, such as paraphthalic acid (or terephthalic acid), isophthalic acid and naphthalic acid). Specific examples of a useful diol include but are not limited to ethylene glycol, propylene glycol, trimethylene glycol, 1,4-butane diol, neopentyl glycol, 1,4-cyclohexane dimethanol (CHDM), cyclohexane diol, and the like. Polyesters may include (a) a homopolymer or copolymer of alkyl-aromatic esters including but not limited to polyethylene terephthalate (PET), amorphous polyethylene terephthalate (APET), crystalline polyethylene terephthalate (CPET), glycol-modified polyethylene terephthalate (PETG) and polybutylene terephthalate, (b) a copolymer of terephthalate and isophthalate including but not limited to polyethylene terephthalate/isophthalate copolymer, (c) a homopolymer or copolymer of aliphatic esters including but not limited to polylactic acid (PLA), (d) polyhydroxyalkonates including but not limited to polyhydroxypropionate, poly(3-hydroxybutyrate) (PH3B), poly(3-hydroxyvalerate) (PH3V), poly(4-hydroxybutyrate) (PH4B), poly(4-hydroxyvalerate) (PH4V), poly(5-hydroxyvalerate) (PH5V), poly(6-hydroxydodecanoate) (PH6D), (e) polyethylene furanoate (PEF), and blends of any of these materials.

As used throughout this application, the term “copolymer” refers to a polymer product obtained by the polymerization reaction or copolymerization of at least two different monomer species. The term “copolymer” is also inclusive of the polymerization reaction of three, four, or more monomer species having reaction products referred to terpolymers, quaterpolymers, etc.

As used throughout this application, the term “modified” refers to a chemical derivative, such as one having any form of anhydride functionality (e.g., anhydride of maleic acid, crotonic acid, citraconic acid, itaconic acid, fumaric acid, etc.), whether grafted onto a polymer, copolymerized with a polymer, or blended with one or more polymers. The term is also inclusive of derivatives of such functionalities, such as acids, esters and metal salts derived from such.

As used throughout this application, the term “polypropylene” or “PP” refers to a homopolymer or copolymer having at least one propylene monomer linkage within the repeating backbone of the polymer. The propylene linkage can be represented by the general formula: —CH₂—CH(CH₃)—.

As used throughout this application, the term “polyethylene” or “PE” refers to, unless indicated otherwise, ethylene homopolymers as well as copolymers of ethylene with at least one alpha-olefin. The term will be used without regard to the presence or absence of substituent branch groups.

As used throughout this application, the term “polycarbonate” refers to an oligomer or polymer including residues of one or more dihydroxy compounds (e.g., dihydroxy aromatic compounds) joined by carbonate linkages. This encompasses homopolycarbonates, copolycarbonates, and (co) polyester carbonates. The polycarbonate may include any polycarbonate material or mixture of polycarbonate materials. The polycarbonate may be a homopolymer including repeating units derived from bisphenol A. The polycarbonate may include polycarbonate monomers such as, but not limited to, 2-phenyl-3,3′-bis(4-hydroxy phenyl) phthalimidine (PPPBP) and dimethyl bisphenol cyclohexane (DMBPC).

The terms “polyamide” or “nylon”, as used herein, refer to homopolymers or copolymers having recurring amide linkages and may be formed by any method known in the art. Recurring amide linkages may be formed by the reaction of one or more diamines and one or more diacids. Non-limiting examples of suitable diamines include 1,4-diamino butane, hexamethylene diamine, decamethylene diamine, metaxylylene diamine, and isophorone diamine. Non-limiting examples of suitable diacids include terephthalic acid, isophthalic acid, 2,5-furandicarboxylic acid, succinic acid, adipic acid, and azelaic acid.

Polyamides may also be formed by the ring-opening polymerization of suitable cyclic lactams like ε-caprolactam, ω-undecanolactam and ω-dodecalactam.

Non-limiting examples of suitable polyamides include poly(ε-caprolactam) (nylon 6), poly(ω-undecanolactam) (nylon 11), poly(ω-dodecalactam) (nylon 12), poly(hexamethylene adipamide) (nylon 6,6), poly(hexamethylene adipamide-co-caprolactam) (nylon 66/6), poly(caprolactam-co-hexamethylene adipamide) (nylon 6/66), poly(caprolactam-co-hexamethylene azelamide) (nylon 6/69), poly(m-xylylene adipamide) (MXD6) and poly(hexamethylene terephthalamide-co-hexamethylene isophthalamide) (nylon 6I/6T).

The first film may be a monolayer film or a multilayer film. With reference to FIG. 1, the first film 12 is shown as a monolayer film. In an embodiment, the first film may be an extrusion coated film. In another embodiment, the first film may be a coextruded multilayer film. In some embodiments, the first film is a blown film. The term “blown film”, as used herein refers to a film produced by the blown extrusion process. In the blown extrusion process, streams of melt-plastified polymers are forced through an annular die having a central mandrel to form a tubular extrudate. The tubular extrudate may be expanded to a desired wall thickness by a volume of fluid (e.g., air or other gas) entering the hollow interior of the extrudate via the mandrel, and then rapidly cooled or quenched by any of various methods known to those of skill in the art.

The multilayer first film includes as many layers as desired and, preferably, at least two layers. In multilayer first films that include at least three layers, the film includes an inner layer. As used throughout this application, the term “inner layer” refers to a layer that is positioned between two other layers. As used throughout this application, the term “surface layer” refers to a layer that does not have another layer on at least one of its major surfaces, (i.e., a surface layer that is on the exterior of the multilayer film). In an embodiment, the first film includes a surface layer of the multilayer packaging film. In another embodiment, the second film includes a surface layer of the multilayer packaging film. In an embodiment, the first film includes a surface layer of the multilayer packaging film and the second film includes an opposing surface layer of the multilayer packaging film.

The second film may be a monolayer film or a multilayer film. With reference to FIG. 1, the second film 14 is shown as a monolayer film. In an embodiment, the second film may be an extrusion coated film. In another embodiment, the second film may be a coextruded multilayer film. In some embodiments, the second film may be a blown film. The multilayer second film includes as many layers as desired and, preferably, at least two layers. In any embodiment, the second film includes a barrier layer that includes a barrier material. In embodiments that include a monolayer second film, the second film is the barrier layer.

The term “barrier layer”, as used herein, refers to a layer that significantly reduces the transmission of one or more molecular species through the layer. A barrier layer may be a surface layer or an inner layer of the second film. A barrier layer may limit or reduce the permeation of migratory species such as moisture, oxygen, and/or other gasses. Barrier layers are typically comprised of metals or polymers that are referred to as “barrier materials”. Barrier materials useful for multilayer packaging films and/or thermoformed components include but are not limited to polymers including ethylene vinyl alcohol copolymer (EVOH), PVDC, high density polyethylene (HDPE), cyclic olefin copolymers (COC), polyamides, polyacrylates, polypropylenes, and metal oxides. Barrier layers may comprise blends of materials. The second film may contain multiple barrier layers, that is, a second barrier layer, a third barrier layer, and so on. The second film may further contain additional layers to provide bulk or adhesion among other things. In some embodiments, the first film additionally may include a layer that includes a barrier material.

In some embodiments of the second film, the barrier layer includes an ethylene vinyl alcohol copolymer. The terms “ethylene vinyl alcohol copolymer” or “EVOH”, as used herein, refer to copolymers comprised of repeating units of ethylene and vinyl alcohol. Ethylene vinyl alcohol copolymers can be represented by the general formula: [(CH₂—CH₂)ₘ—(CH₂—CH(OH))ₙ]. Preferably, ethylene vinyl alcohol copolymers comprise from about 25 mole percent to about 48 mole percent ethylene. The type of EVOH may be selected to be one of the grades especially designed for thermoforming applications, as are known in the art. An example of EVOH that may be thermoformable is Soarnol™ ET3803 (38 mol % ethylene content) available from Soarus L.L.C. EVOH is known to reduce the permeation of oxygen and other gasses through polymeric based packaging films. EVOH includes a density from 1.12 g/cm³ to 1.24 g/cm³.

The multilayer packaging film may have an oxygen transmission rate when an oxygen barrier material such as EVOH is included in the multilayer packaging film composition of less than 20 cubic centimeters per meter² per 24 hours (cc/m²/24 hours), or between 0.05 cc/m²/24 hours and 5.0 cc/m²/24 hours, between 5.0 cc/m²/24 hours and 10.0 cc/m²/24 hours, between 10.0 cc/m²/24 hours and 20.0 cc/m²/24 hours, or any range or combination of ranges therein, where cc is cubic centimeters, when measured at 23° C. and 0% relative humidity (RH) using ASTM D3985. The multilayer packaging film may have an oxygen transmission rate of less than 500 cubic centimeters per meter² per 24 hours (cc/m²/24 hours). Without an oxygen barrier material such as EVOH for example, the multilayer packaging film may include an oxygen transmission rate from 2,000 cc/m²/24 hours or greater. In some embodiments, the multilayer packaging film may include an oxygen scavenging material.

The barrier layer may provide moisture barrier. Some embodiments of the barrier layer may include high density polyethylene (HDPE) for moisture barrier improvements. The terms “high density polyethylene” or “HDPE”, as used herein, refer to both (a) homopolymers of ethylene that may have densities from about 0.960 g/cm³ to about 0.970 g/cm³ and (b) copolymers of ethylene and an alpha-olefin (usually 1-butene or 1-hexene) that may have densities from about 0.940 g/cm³ to about 0.958 g/cm³. HDPE includes polymers made with Ziegler or Phillips type catalysts, polymers made with single-site metallocene catalysts, and polymers made with non-metallocene single-site catalysts. HDPE also includes high molecular weight “polyethylenes”.

In contrast to HDPE, whose polymer chain may exhibit sparse branching, are “ultra high molecular weight polyethylenes”, which are essentially unbranched specialty polymers having a much higher molecular weight than the high molecular weight HDPE. HDPE includes a density from 0.94 g/cm³ to 0.97 g/cm³. The second film may include one, two, three, four, or more separate layers comprising HDPE, each consisting essentially of HDPE. That is, the HDPE may be accompanied by other minor components such as slip, antiblock, processing aid, nucleation additives, or hydrocarbon additives, such that the blend consists of at least 80% HDPE.

Some embodiments of the barrier layer may include polypropylene (PP) for moisture barrier improvements. The second film may include one, two, three, four, or more separate layers comprising PP, each consisting essentially of PP. That is, the PP may be accompanied by other minor components such as slip, antiblock, processing aid, nucleation additives, or hydrocarbon additives, such that the blend consists of at least 80% PP. In some embodiments, the second film may include more than one barrier layer where each barrier layer includes a barrier material that is different from at least one of the other barrier layers.

The multilayer packaging film may have a moisture transmission rate, when a moisture barrier material is included in the multilayer packaging film compositions of less than 15.5 grams per meter² per 24 hours (g/m²/24 hours), between 0.0155 g/m²/24 hours and 15.0 g/m²/24 hours, or between 0.05 g/m²/24 hours and 10.0 g/m²/24 and including any range or combination of ranges therein when measured at 38° C. and 90% RH using ASTM F1249.

The first film and/or the second film may include a pigment within any of the polymer layer(s) that form the first and second films. Pigment is often included in the structure to produce colored components or components that require light blocking. In some instances, the pigmented first film or second film provides optical detection in a wash-sink-float-separation process. The layer or layers including the pigment may be located centrally to the multilayer packaging film structure. In this context, the term “centrally” is meant to indicate that the pigment is near the center of the structure, although may not be necessarily at exactly the center of the structure. In an embodiment, the barrier layer includes the pigment. In another embodiment, the barrier layer including HDPE includes the pigment.

Other inner layers of the second film may comprise any materials known to be compatible and useful to packaging. Inner layers may be functional. For example, inner layers may provide barrier (barrier materials), adhesion (adhesive or tie materials), thermoforming stability, or any other function known to be useful for multilayer packaging films.

As used throughout this application, the term “tie material” refers to a polymeric material serving a primary purpose or function of adhering two surfaces to one another, typically the planar surfaces of two film layers. A tie material adheres one film layer surface to another film layer surface. The tie material may comprise any polymer, copolymer or blend of polymers having a polar group or any other polymer, homopolymer, copolymer or blend of polymers, including modified and unmodified polymers (such as grafted copolymers), which provide sufficient interlayer adhesion to adjacent layers comprising otherwise non-adhering polymers.

The primer layer that includes a water dispersible material is positioned between the first film and the second film. The primer layer is uniquely configured to (a) facilitate bond strength between the first film and the second film such that the multilayer packaging film can withstand formation into a package and fulfill its intended function, and (b) allow for separation of the first film from the second film. For example, the primer layer can partially or completely dissolve in a wash-sink-float-separation process. The multilayer packaging film, or resulting thermoformed components, advantageously provide barrier and are able to contain high moisture content products without separation between the first and second films until subjected to a separation process.

The multilayer packaging film includes interlaminar bond strength between the first film and the second film as indicated by peak bond strength and average bond strength according to ASTM F 904-98 (Reapproved 2003). The interlaminar bond strength is a measurement between the primer layer and the first film and/or the second film depending upon where a separation interface occurs. In some instances, the separation interface may occur between (a) the first film and the primer layer, (b) the second film and the primer layer, (c) within the primer layer, or (d) a combination of (a) through (c). A peak or average bond strength between the first film and the second film disclosed herein, includes a measurement of (a), (b), (c), or (d). In some instances, the multilayer packaging film can include relatively low peak and average interlaminar bond strengths and in other instances, relatively high peak and average interlaminar bond strengths. For example, a multilayer packaging film that is a thermoformable film that will be formed into a thermoformed component, may only need to have enough interlaminar bond strength to keep the first film bonded to the second film until the multilayer packaging film undergoes a thermoforming process. In another example, a multilayer packaging film that will be formed into a flexible film package may need to have high interlaminar bond strength. The bond strength must be suitable for the particular packaging application as understood by one of skill in the art.

In an embodiment, the multilayer packaging film may include a peak bond strength of from 20 g/25.4 mm or greater between the first film second surface and the second film first surface according to ASTM F 904-98 (Reapproved 2003). In an embodiment, the multilayer packaging film may include a peak bond strength of 100 g/25.4 mm, 200 g/25.4 mm, 300 g/25.4 mm, 400 g/25.4 mm, 500 g/25.4 mm, 600 g/25.4 mm, 700 g/25.4 mm, 800 g/25.4 mm, 900 g/25.4 mm, or 1,000 g/25.4 mm. In other embodiments, the multilayer packaging film may include a peak bond strength of greater than 1,000 g/25.4 mm, 2,000 g/25.4 mm, or greater. In some embodiments, the multilayer packaging film may include a peak bond strength that is so great, the first film and the second film do not separate or that causes destruction of at least one of the first or second films.

In an embodiment, the multilayer packaging film may include an average bond strength of from 20 g/25.4 mm or greater between the first film second surface and the second film first surface according to ASTM F 904-98 (Reapproved 2003). In an embodiment, the multilayer packaging film may include an average bond strength of 100 g/25.4 mm, 200 g/25.4 mm, 300 g/25.4 mm, 400 g/25.4 mm, 500 g/25.4 mm, 600 g/25.4 mm, 700 g/25.4 mm, 800 g/25.4 mm, 900 g/25.4 mm, or 1,000 g/25.4 mm. In other embodiments, the multilayer packaging film may include an average bond strength of greater than 1,000 g/25.4 mm, 2,000 g/25.4 mm, or greater. In some embodiments, the multilayer packaging film may include an average bond strength that is so great, the first film and the second film do not separate or that causes destruction of at least one of the first or second films.

The primer layer includes a water dispersible material. The term “water dispersible”, as used herein, refers to a material that may be dispersible, soluble, or emulsifiable in water or another solvent. The material may include but is not limited to an acidic moiety, a sulfopolyester, or a waterborne polyurethane (e.g., polyester urethanes and polyether urethanes). “Dispersible”, as used in this application, means that some structure of the water dispersible material is retained (e.g., material or particles are suspended in the solvent). “Soluble”, as used in this application, means that the water dispersible material dissolves in the solvent. “Emulsifiable”, as used in this application, means that the water dispersible material is present as droplets, of microscopic or ultramicroscopic size, and is distributed throughout the solvent with a surfactant or a stabilizer. Non-limiting examples of suitable solvents include water or isopropyl alcohol (IPA).

The water dispersible material may be present in a water dispersible coating that forms the primer layer in a range of from 1% to 50% of the water dispersible coating by weight or any range or combination of ranges therein, that is indicative of the percent solids in a wet state. In an embodiment, the water dispersible material may be present in the water dispersible coating from 1%, 2%, 3%, 4%, 5%, 10%, 15%, 20%, 25%, 30%, 35%, 40%, 45%, or 50% of the water dispersible coating by weight. In an embodiment, the water dispersible material may be present in the water dispersible coating by weight in a range of from 1% to 5%, 5% to 10%, 10% to 15%, 15% to 20%, 20% to 25%, 25% to 30%, 30% to 35%, 35% to 40%, 40% to 45%, 45% to 50%, or any range or combination of ranges therein. In some embodiments, the water dispersible coating may further include a photoinitiator or photosensitizer. That is, the water dispersible material may be accompanied by other minor components in the water dispersible coating.

Water dispersible acidic moieties may include copolymers of monobasic ethylenically unsaturated carboxylic acids with ethylene, such as ethylene acrylic acid (EAA) or ethylene methacrylic acid (EMAA) that may be partially neutralized with metal salts, for example, sodium or zinc. Water dispersible acidic moieties may further include polyacrylic acids (PAA) such as ionically or covalently crosslinked polycarboxylates, polymethacrylates such as polymethacrylic acid (PMAA), mixtures of polyacrylic acid and polymethacrylic acid, and partially or fully neutralized forms thereof. In an embodiment, the water dispersible material including acidic moieties may include EAA, EMAA, PAA, PMAA, or combinations thereof. Suitable water dispersible acidic moieties, such as PAA, include those available under the trade name of ACUMER developed by Dow.

Water dispersible sulfopolyesters are formed by melt-phase polymerization of glycols and aromatic diacids. Typical monomers used in the production of water dispersible sulfopolyesters include isophthalic acid, 5-sodiosulfoisophthalic acid, 1,4-cyclohexanedimethanol, and diethylene glycol. Suitable water dispersible sulfopolyesters include those available under the trade name of EASTEK polymer dispersions developed by Eastman.

In some embodiments, the multilayer packaging film may include a second first film. With refence to FIG. 2, a multilayer packaging film 20 includes a first film 22, a second first film 23, a primer layer 26, and a second film 24. The first film 22 includes a first surface 25 that includes a first surface of the multilayer packaging film and an opposing second surface 27. The second first film may have the same composition as or differ from the composition of the first film. The second first film 23 includes a first surface 29 and an opposing second surface 21 that includes a second surface of the multilayer packaging film 20.

The multilayer packaging film 20 includes a thickness 100. The first film 22 includes a first film thickness 102, the primer layer 26 includes a primer layer thickness 104, and the second film 24 includes a second film thickness 106. The second first film 23 includes a second first film thickness 108. The primer layer thickness may be in a range of from greater than 0% to 20% of the thickness of the multilayer packaging film. In an embodiment, the primer layer thickness may be from 0.01% to 0.1%, 0.1% to 0.5%, 0.5% to 1%, 1% to 5%, 5% to 10%, 10% to 15%, 15% to 20%, or any range or combination of ranges therein of the multilayer packaging film.

The second film may be a monolayer or a multilayer film that includes a barrier layer that includes a barrier material. The second film 24 is shown as a monolayer film in FIG. 2 that includes the barrier layer. The second film may include as many layers as desired in addition to the barrier layer when the second film is a multilayer film.

In an embodiment, the multilayer packaging film includes a first film including a first polymer that includes polyester and the second film includes a barrier layer that includes a barrier material of EVOH. In another embodiment, the multilayer packaging film includes a first film including a first polymer that includes polyester and the second film includes a barrier layer that includes a barrier material of HDPE. In a further embodiment, the multilayer packaging film includes a first film including a first polymer that includes polyester and the second film includes a barrier layer that includes a barrier material of PP.

The primer layer is connected to the first film and the second film. In an embodiment, the first film is directly connected to (e.g., adjoins) the primer layer. In an embodiment, the first film is indirectly connected to the primer layer. In an embodiment, the second film is directly connected to (e.g., adjoins) the primer layer. In an embodiment, the second film is indirectly connected to the primer layer. In an embodiment, the water dispersible coating forming the primer layer may be applied onto an outer surface of the first film (e.g., first film second surface) by any conventional coating means known in the art (e.g., printing, spray coat, knife coat, etc.) before the first film is connected to the second film. In another embodiment, the water dispersible coating forming the primer layer may be applied to an outer surface of the second film (e.g., second film first surface) before the second film is connected to the first film. In other embodiments, the water dispersible coating that forms the primer layer may be applied to both the first film and the second film.

The first film and the second film may be connected by any conventional means known in the art, such as by heat, adhesive, or by extrusion coating (e.g., extrusion coating a first film onto a second film that includes a primer layer). In any embodiment, the primer layer is positioned between the first film and the second film. In an embodiment, the primer layer is directly connected to the first film and the second film. In an embodiment, the primer layer is indirectly connected to the first film and the second film. In an embodiment, the primer layer is coextensive with the first film and the second film. In an embodiment, the primer layer may include a dry basis weight in a range of from 0.08 grams per meter² (gsm) to 8.14 gsm (0.05 pounds per ream (lb/rm) to 5.0 lb/rm), or any range or combination of ranges therein. In other embodiments the primer layer dry basis weight may be greater than 8.14 gsm.

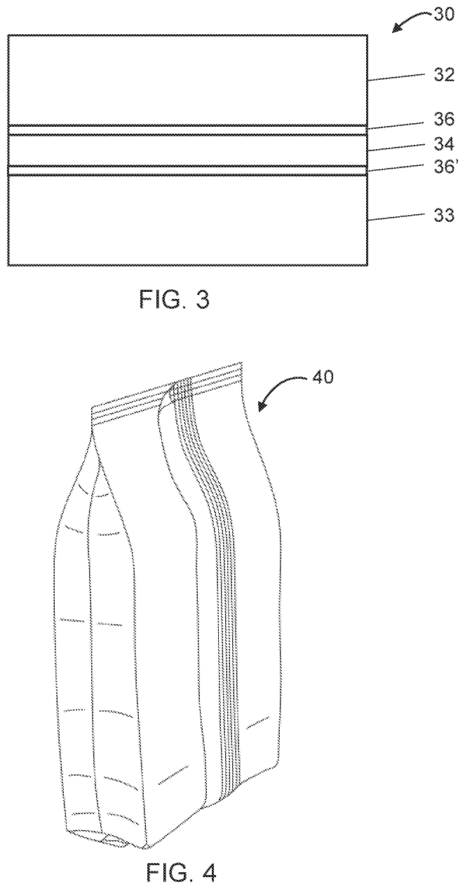

The multilayer packaging film may include additional primer layers along with the primer layer previously discussed. Referring to FIG. 3, a multilayer packaging film 30 that includes a primer layer 36 is shown. The primer layer 36 is positioned between a second film 34 and a first film 32. The multilayer packaging film 30 includes a second first film 33 and a second primer layer 36′. The second primer layer 36′ is positioned between the second film 34 and the second first film 33. The second first film 33 may have the same composition as or differ from the composition of the first film 32. Similarly, the second primer layer 36′ may have the same composition as or differ from the composition of the primer layer 36. In an embodiment, the second first film is directly connected to the second primer layer. In an embodiment, the second first film is indirectly connected to the second primer layer.

The first film that includes the first polymer may include a thickness that may contribute stiffness to a thermoformed component or part. The required thickness of the thermoformed component may be dependent on the type of material used in the first film. For example, polyester- or polystyrene-based polymers may thermoform easily and evenly and may provide appropriate final part stiffness at a lower thickness when compared to polymers that do not thermoform well or provide the appropriate stiffness. In general, the overall thickness of the first film should be in a range of from 76 microns (3 mil) to 2,540 microns (100 mil) or any range or combination of ranges therein. In some embodiments, the first film thickness is greater than 254 microns (10 mil), greater than 381 microns (15 mil), or greater than 508 microns (20 mil). In other embodiments, the first film thickness is in a range of from 152 microns (6 mil) and 1,270 microns (50 mil) or any range or combination of ranges therein. In some other embodiments the first film thickness is in a range of from between 254 microns (10 mil) and 1,016 microns (40 mil) or any range or combination of ranges therein. In embodiments where the multilayer packaging film includes a second first film, the second first film may be identical or different in structure, composition, and thickness as the first film. The thickness of each of the first film and the second first film may be the same, similar, or different. A thickness ratio of the first film thickness to the second first film thickness may be in a range of from 2:1 and 1:2 or any range or combination of ranges therein. In some embodiments the thickness ratio is 1:1. In embodiments where the multilayer packaging film includes a second primer layer, the second primer layer may be identical or different in structure, composition, and thickness as the first primer layer. The thickness of each the first primer layer and the second primer layer may be the same, similar, or different. A thickness ratio of the first primer layer thickness to the second primer layer thickness may be in a range of from 2:1 and 1:2 or any range or combination of ranges therein. In some embodiments the thickness ratio is 1:1.

The thickness of the second film that includes the barrier layer may have a thickness of less than 127 microns (5 mil). The second film may have a thickness in a range of from 25.4 microns (1 mil) and 200 microns (7.8 mil), more particularly from 76 microns (3 mil) to 140 microns (5.5 mil), or any range or combination of ranges therein.

In various non-limiting embodiments, the multilayer packaging film may be like the structures listed below, where “//” indicates lamination:

$$PET // primer / PE / tie / EVOH / tie / PE$$

$$PET / primer // PE / tie / EVOH / tie / PE$$

$$PET // primer / HDPE / tie / EVOH / tie / HDPE / tie / PET$$

$$PET / primer // HDPE / tie / EVOH / tie / HDPE / tie / PET$$

$$PET // primer / HDPE / tie / EVOH / tie / HDPE / EVA / EVA / HDPE / tie / EVOH / tie / HDPE$$

$$PET / primer // HDPE / tie / EVOH / tie / HDPE / EVA / EVA / HDPE / tie / EVOH / tie / HDPE$$

$$PET // primer / HDPE / tie / EVOH / tie / HDPE / EVA / EVA / HDPE / tie / EVOH / tie / HDPE // PET$$

$$PET / primer // HDPE / tie / EVOH / tie / HDPE / EVA / EVA / HDPE / tie / EVOH / tie / HDPE // PET$$

$$PP // primer / PE / tie / EVOH / tie / PE$$

$$PP / primer // PE / tie / EVOH / tie / PE$$

$$BOPA // primer / PE / tie / EVOH / tie / PE \\ ( BOPA is biaxially oriented polyamide )$$

$$HIIPS / primer // PE / tie / EVOH / tie / PE$$

### Recyclable Film

The multilayer packaging films described herein may be recycled after their primary use is completed such that the multilayer packaging film is a recyclable film. The term “suitable for recycling”, as used herein, is meant to indicate that the film can be converted into a new, useful item by means of reprocessing in a recycle stream (e.g., recycling streams based on the first polymer or single polymer). Reprocessing may entail washing, separating, melting, and forming, among many other steps. Typically, when flexible polymeric packaging is recycled by reprocessing, the material is mechanically chopped into small pieces (e.g., granulated, flaked, etc.), melted, mixed, and reformed into the new product. If multiple incompatible materials are present in the packaging, interactions occur during reprocessing that can cause gels, brittle material, poor appearance, and generally unusable or poor quality products. Using the term “recyclable” indicates that these drawbacks generally are not present. Qualification as a recyclable material is not regulated by any specific agencies but can be obtained from groups such as the Association of Plastic Recyclers (APR) and How2Recycle™.

The first polymer of the multilayer packaging film may be recovered in a wash-sink-float-separation process that allows the first polymer to be recycled. Polymers of the second film may also be recovered and recycled. A wash-sink-float-separation process prescribes the multilayer packaging film to be granulated (e.g., flaked, cut into small pieces, etc.) and subjected to the wash step of the process. The primer layer partially or completely dissolves in the wash step of the process. The dissolvability of the primer layer or any additional primer layers may allow the granulated first film including the first polymer to sink and the granulated second film to float or in other configurations, may allow the first film to float and the second film to sink, depending upon the materials selected for the first film and the second film. The granulated first film and/or the granulated second film may include a portion of the granulated primer layer if the primer layer did not completely dissolve. In an embodiment, the average density of the second film is less than the density of the first polymer. In an embodiment, the average density of the second film is less than the average density of the first film. In an embodiment, the first film includes a first polymer including polyester having a density from 1.23 g/cm³ to 1.40 g/cm³. In this embodiment, the second film may include a barrier layer including an average density lower than the polyester density. In another embodiment, the first film includes a first polymer including polypropylene having a density from 0.895 g/cm³ to 0.91 g/cm³. In this embodiment, the second film may include a barrier layer including an average density lower than the polypropylene density. A non-limiting process for separating dissimilar materials that includes a granulating process is a wash-sink-float-separation process for the recovery of polyester that is described in a protocol according to the Association of Plastic Recyclers in Document Number PET-P-00, dated Sep. 17, 2019, steps PET-P-01 through PET-P-04 (pages 3-12). Many other processes to separate dissimilar materials may be used as known by one of skill in the art.

In an embodiment, the recyclable film includes a first film that includes greater than 95% of a single polymer. As used in this application, the term “single polymer”, may include single polymer or a blend of the same category of a particular polymer type. In an embodiment, the first film may include greater than 95% of a blend of polyester polymers. In an embodiment, the first film may include greater than 95% of a blend of polypropylene polymers

The positioning and composition of the primer layer allows the first film to separate from the second film, for example, in a wash-sink-float separation process, where the single polymer can be recovered and recycled. Recyclable films disclosed herein may be suitable for single polymer recycling streams, such as polyester or polypropylene. Introduction of the recovered portion of the recyclable film into any of these recycling-by-reprocessing avenues may not require additional compatibilizer.

Being suitable for recycling may be obtained by keeping the overall amount of the single polymer in the first film at a high level. Any additives used should be kept to a minimum. Any non-single polymers that are present should be minimized. The total composition of the first film may include a single polymer in an amount in a range of from 90% to 100% of the single polymer by weight, including any range or combination of ranges therein. In some embodiments, the total composition of the first film is greater than 90%, or greater than 95% of a single polymer by weight. In an embodiment, the single polymer is present in an amount in a range of from 95% to 100% of the first film by weight.

The single polymer of the first film may be selected from any of those previously described that may be used as the first polymer of the multilayer packaging film of this disclosure. The single polymer can be carefully selected based on its capability to be recycled in a single polymer stream (i.e., recyclable polymer).

The single polymer of the first film of the recyclable film may be recovered in a wash-sink-float-separation process that allows the single polymer to be recycled. The primer layer partially or completely dissolves in the wash step of the process. The dissolvability of the primer layer may allow the granulated first film including the single polymer to sink and the granulated second film to float or may allow the granulated first film including the single polymer to float and the granulated second film to sink, depending upon the materials selected for the first film and the second film. The granulated second film may include a portion of the granulated primer layer if the primer layer did not completely dissolve. In an embodiment, the average density of the second film is less than the average density of the first film. In another embodiment, the average density of the first film is less than the average density of the second film. In an embodiment, the first film includes a single polymer including a density in a range of from 1.23 g/cm³ to 1.40 g/cm³ and the second film includes an average density that differs from the first film average density. In another embodiment, the first film includes a single polymer including a density in a range of from 0.895 g/cm³ to 0.92 g/cm³ and the second film includes an average density that differs from the first film average density. A granulating process and a wash-sink-float-separation process may be utilized for the recovery of the single polymer.

It was surprisingly found that the primer layer, which constitutes a small portion of the recyclable film structure, (a) can provide adequate interlaminar bond strength of the first film to the second film and (b) is resistant to dissolution when packages and packaging components formed from the recyclable film contain high moisture content product. The term “dissolution”, as used herein, refers to structures including layers or films and a primer layer where the separation of the layers or films from each other is due to partial or complete dissolvability of the primer layer. The primer layer includes water dispersible materials and the layers or films that may separate therefrom may be devoid of primer layer water dispersible materials.

### Packaging and Packaged Product

The multilayer packaging films, thermoformable films, and recyclable films disclosed herein can undergo a thermoforming process to form a thermoformed component of a package. Thermoforming is a process by which a film is permanently formed into a desired shape by the application of (a) a differential pressure between the sheet and a mold, (b) heat, (c) the combination of heat and the application of a differential pressure between the film or sheet and a mold, or by any thermoforming technique known to those skilled in the art. In some package embodiments, the multilayer packaging films, thermoformable films, and recyclable films are not thermoformed and may be used to form flexible film packages such as stand-up pouches, sachets, or pillow packs. In other embodiments, the multilayer packaging films, thermoformable films, and recyclable films may be formed around a forming collar of a packaging machine (e.g., cold forming, cold formed) for proper processability and for the formation of a shallow pocket (e.g., 15 mm to 25 mm) in the film that is desirable for packages referred to as a “deli pack” or a “sandwich pack”, for example. In another example, the multilayer packaging films, thermoformable films, and recyclable films may be formed into trays or other rigid packaging components or parts where the film may also have pockets formed therein at a deeper draw than cold forming. Thermoformed components may have one or more compartments and may take a wide variety of shapes and designs. The thermoformed component may include another component (e.g., lidding material, another thermoformed component, etc.) to form a package that contains a product.

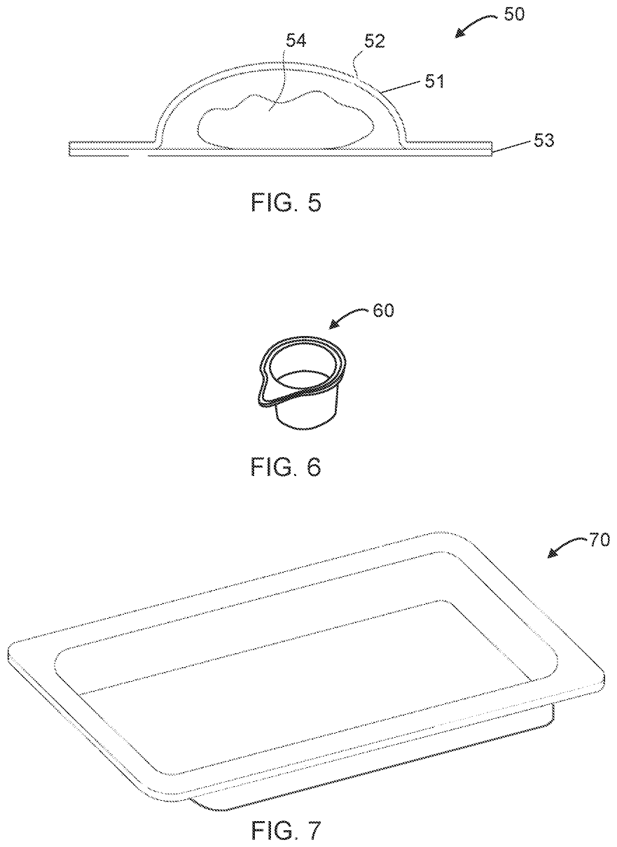

Non-limiting examples of packages that may be formed from the multilayer packaging films, thermoformable films, or recyclable films disclosed herein are shown in FIGS. 4-7. Packages including little to no degree of thermoforming are shown in FIGS. 4-5. Other thermoformed components are shown in FIGS. 6-7. The packages or package components may contain a variety of products, food or non-food, that include a moisture content ranging from 0% to 100% or any range or combination of ranges therein. Packages or thermoformed components formed from the multilayer packaging films, thermoformable films, and recyclable films disclosed herein are well suited to contain products that include a moisture content of greater than 30%, for example, 40%, 50%, 60%, 70%, 80%, 90%, 100%, or any moisture content therebetween. In an embodiment, packages or thermoformed components resulting from the multilayer packaging films, thermoformable films, or recyclable films described herein, contain a product including a moisture content of greater than 30%.

A package 40 shown in FIG. 4 is a side-gusseted pouch that may be fabricated in a form-fill-seal process. Non-limiting package examples include a stand-up pouch, a pillow pouch, a retort pouch, a sachet, a brick bag, a flow wrap bag, a stick pack, and the like. A package 50 that is shown in FIG. 5 is a cold formed package that includes a base film 51 that includes the multilayer packaging films, thermoformable films, or recyclable films disclosed herein. The package 50 further includes a lidding film 53 and the package 50 may be suited to contain a breakfast sandwich for example. The base film 51 includes a shallow, cold formed pocket 52. A product 54 is contained in package 50.

A thermoformed component 60 is shown in FIG. 6 as a liquid creamer cup. The liquid creamer cup may contain products having a moisture content of up to 100% (e.g., juices, gelatin snacks, liquid coffee creamer). The thermoformed component 60 may contain products with little to no moisture content, for example, coffee pod cups. Thermoformed components may be cup-shaped (e.g., relatively large draw depth with respect to component opening size) and may include volumes greater than the liquid creamer cup thermoformed component 60 shown in FIG. 6. For example, cup-shaped thermoformed components may contain products such as pudding or yogurt that include a moisture content in a range of about 75% to about 85%.

Thermoformed component 70 is shown in FIG. 7 as a tray. The tray may contain meat or poultry having a moisture content from about 55% to about 75%. Thermoformed components that are tray-shaped (e.g., relatively small draw depth with respect to component opening size) may include different volumes to contain different products, for example, snacks such as nuts having a moisture content from about 1% to about 20%, or cheese having a moisture content from about 30% to about 80%.

### Method of Making Multilayer Packaging Film

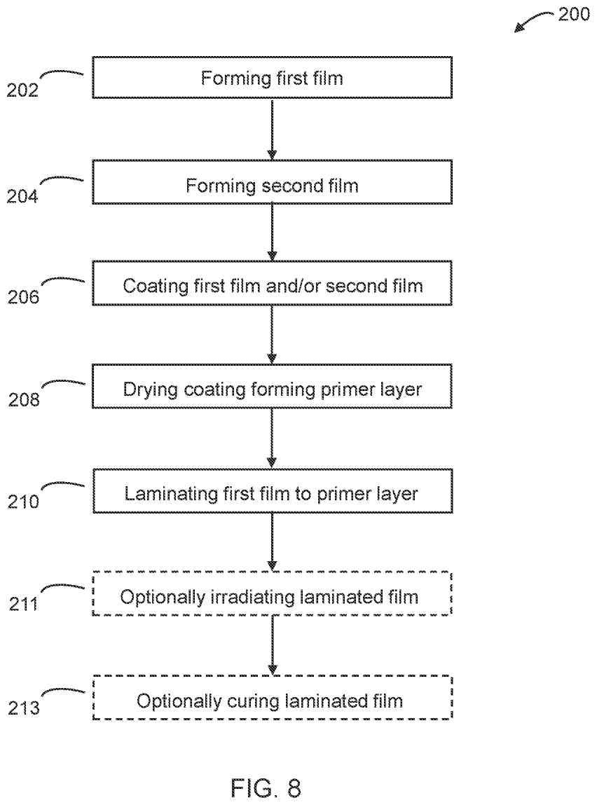

A method of making a multilayer packaging film is disclosed herein. With reference to FIG. 8, a method 200 of making a multilayer packaging film is shown.

At operation 202 of method 200, a first film is formed that includes a first polymer. The first film includes a first surface and a second surface.

At operation 204 of method 200, a second film is formed that includes a barrier layer, a first surface, and a second surface. The barrier layer includes a barrier material.

At operation 206 of method 200, the first film, the second film, or both the first and second films are coated with a water dispersible coating that includes a water dispersible material in a wet state. The first film second surface, the second film first surface, or combinations thereof, may be coated with the water dispersible coating. The water dispersible coating may include a range of from 1% to 50% of a water dispersible material by weight of the water dispersible coating.

At operation 208 of method 200, the water dispersible coating is dried from the wet state to a dry state to form a primer layer on the coated film surface (i.e., the first film, the second film, or both the first and second film). When both the first and second films are coated with the water dispersible coating, the coating on each of the first film and the second film collectively forms the primer layer. The primer layer dry state may include a dry basis weight, indicative of remaining solids, in a range of from 0.08 grams per meter² (gsm) to 8.14 gsm (0.05 pounds per ream (lb/rm) to 5.0 lb/rm), or any range or combination of ranges therein. In other embodiments the primer layer dry basis weight may be greater than 8.14 gsm (5.0 lb/rm).

At operation 210 of method 200, the first film is laminated to the second film forming a multilayer packaging film where the primer layer is positioned between the first film and the second film. In an embodiment, the first film first surface may include an exterior (e.g., exposed, outer) surface of the multilayer packaging film. In an embodiment, the second film second surface may include an exterior (e.g., exposed, outer) surface of the multilayer packaging film. Lamination means may include any conventional means known in the art, such as heat or adhesive.

In an embodiment, the first film, the primer layer, and the second film are coextensive. In another embodiment, the primer layer is patterned and is positioned between the first film and the second film. In an embodiment, the primer layer directly connects the first film and the second film. In an embodiment, the primer layer indirectly connects the first film and the second film.

Optionally, the multilayer packaging film (i.e., laminated first film and second film) may undergo irradiating at operation 211 of method 200 with actinic or electron beam radiation. Actinic radiation includes electromagnetic radiation that can produce photochemical reactions. Actinic radiation may include wavelengths that include infrared, visible, and ultraviolet light. The dose of actinic irradiation may include from 5 mJ/cm² to 3,000 mJ/cm², 10 mJ/cm² to 2,000 mJ/cm², 15 mJ/cm² to 1,000 mJ/cm², or any range or combination of ranges therein.

Optionally, the multilayer packaging film (i.e., laminated first film and second film) may undergo curing at operation 213 of method 200 by methods understood in the art, for example, heat or forced air. The curing operation may take place after the irradiating operation.

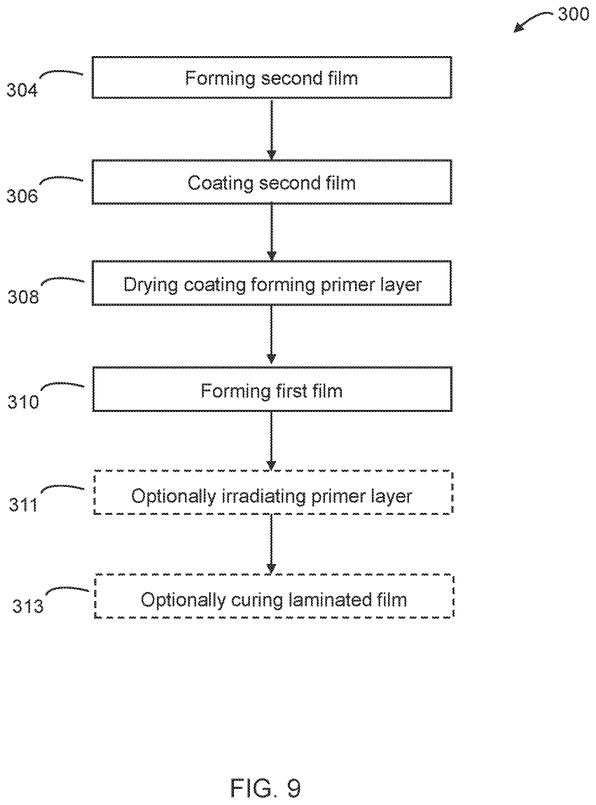

Another method of making a multilayer packaging film is disclosed herein. With reference to FIG. 9, a method 300 of making a multilayer packaging film is shown.

At operation 304 of method 300, a second film is formed that includes a barrier layer, a first surface, and a second surface. The barrier layer includes a barrier material.

At operation 306 of method 300, the second film first surface is coated with a water dispersible coating that includes a water dispersible material in a wet state. The water dispersible coating may include the water dispersible material in a range of from 1% to 50% or any range or combination of ranges by weight of the water dispersible coating.

At operation 308 of method 300, the water dispersible coating is dried from the wet state to a dry state to form a primer layer on the second film. The primer layer may be coextensive with the second film. The primer layer may be patterned on the second film. The primer layer may be indirectly connected to the second film (e.g., an intervening layer between the second film and the primer layer). The primer layer that is in a dry state may include a dry basis weight in a range of from 0.08 grams per meter² (gsm) to 8.14 gsm (0.05 pounds per ream (lb/rm) to 5.0 lb/rm), or any range or combination of ranges therein. In other embodiments the primer layer dry basis weight may be greater than 8.14 gsm.

At operation 310 of method 300, a first film is formed that includes a first polymer. The first film is extrusion coated onto the second film such that the primer layer is positioned between the first film and the second film. The first film includes a first surface and a second surface. In an embodiment, the first film first surface may include an exterior surface of the multilayer packaging film. In an embodiment, the second film second surface may include an exterior surface of the multilayer packaging film.

In any embodiment, the primer layer is positioned between the first film and the second film. In an embodiment, the primer layer is coextensive with the first film and/or the second film. In an embodiment, the first film, the primer layer, and the second film are coextensive. In an embodiment, the primer layer is patterned. In an embodiment, the primer layer adjoins the first film and the second film. In an embodiment, the primer layer indirectly connects the first film and the second film.

Optionally, the multilayer packaging film (i.e., laminated first film and second film) may undergo irradiating at operation 311 of method 300 with actinic or electron beam radiation. Actinic radiation includes electromagnetic radiation that can produce photochemical reactions. Actinic radiation may include wavelengths that include infrared, visible, and ultraviolet light. The dose of actinic irradiation may include from 5 mJ/cm² to 3,000 mJ/cm², 10 mJ/cm² to 2,000 mJ/cm², 15 mJ/cm² to 1,000 mJ/cm², or any range or combination of ranges therein.

Optionally, the multilayer packaging film (i.e., laminated first film and second film) may undergo curing at operation 313 of method 300 by methods understood in the art, for example, heat or forced air. The curing operation may take place after the irradiating operation.

### Test Methods

Material Balance Evaluation: The Association of Plastic Recyclers (APR) in Document Number PET-P-00, dated Sep. 17, 2019, steps PET-P-01 through PET-P-04 (pages 3-12 of the protocol document).

Materials used for APR detergent wash solution were Triton X-100 nonionic surfactant and sodium hydroxide, NaOH, solution.

Interlayer adhesion bond strength: ASTM F904-98 (Reapproved 2003).

### EXAMPLES

Various embodiments will be further clarified by the following examples.

### Examples 1-10

Example films were produced according to the general structure shown in FIG. 1. Material Balance Evaluation PET-S-04 (page 9 of the PET-P-00 document described in the Test Methods section of this disclosure) was completed for each sample and the time of complete separation recorded. Additionally, interlayer adhesion bond strength (peak and average) was measured for each sample.

Examples 1-11 included a thickness of 406.4 microns (16 mil). The examples included a first film and a second film. The first film was amorphous polyester (APET) having a thickness of 355.6 microns (14 mil). The second film was a multilayer film that included layers of (a) a blend of very low density polyethylene (VLDPE) with linear low density polyethylene (LLDPE), (b) ethylene vinyl alcohol copolymer (EVOH), (c) a peelable composition of polybutene (PB) blended with EVA, and (d) ethylene-vinyl acetate (EVA). The multilayer film included a tie layer. The second film had a thickness of 50.8 microns (2 mil) and included the following structure:

$$VLDPE - LLDPE Blend / tie / EVOH / tie / EVA - PB Blend / EVA$$

Each example included a coating of water dispersible material that was applied to the second film. The coating was dried to form a primer layer. The primer layer had a dry coat weight of 0.32 gsm (0.2 lb/ream). The first film included APET and was extrusion coated onto the second film such that the primer layer was positioned between and adjoined the APET film and the multilayer film. The examples included the following structure:
APET/Primer layer/VLDPE-LDPE Blend/tie/EVOH/tie/EVA-PB Blend/EVA

Examples 1-9 included a water dispersible coating that included a water dispersible ethylene acrylic acid copolymer. Each example film included a different percent solids of the water dispersible ethylene acrylic acid copolymer in the coating that is reported in TABLE 1. Suitable solvents were used as the balance of the coating.

Examples 10-11 included a water dispersible coating that included a water dispersible sulfopolyester. Each example film included the same percent solids of the water dispersible sulfopolyester in the coating that is reported in TABLE 1. Suitable solvents were used as the balance of the coating.

Examples 1-5 and Example 10 were irradiated up to exposure levels of 3,000 mJ/cm².

Example 5 was cured.

The water dispersible coating for each example film is summarized in TABLE 1. Coatings including ethylene acrylic acid copolymer water dispersible material are noted as “EAA” and coatings including sulfopolyester water dispersible material are noted as “SP”.

Peak and average bond strengths were measured for each example film. Separation time upon complete separation according to Materials Balance Evaluation, PET-P-04 was recorded. The bond strengths and separation time for each example film are summarized in TABLE 1.

TABLE 1

| | | | | Average | |
|---|---|---|---|---|---|
| | Coating | | Peak Bond | Bond | Separation |
| Example | (% Solids | | Strength | Strength | Time |
| Film | and Material) | Irradiated | (g/in) | (g/in) | (minutes) |
| 1 | 1% EAA | Yes | 2,328 | 2,003 | 90 |
| 2 | 2% EAA | Yes | 1,921 | 1,384 | 90 |
| 3 | 4% EAA | Yes | 1,952 | 1,654 | 90 |
| 4 | 8% EAA | Yes | 1,863 | 1,655 | 90 |
| 5 | 20% EAA | Yes | 2,132 | 2,005 | 15 |
| 6 | 1% EAA | No | 1,087 | 787 | 90 |
| 7 | 2% EAA | No | 1,096 | 637 | 90 |
| 8 | 4% EAA | No | 487 | 105 | 90 |
| 9 | 8% EAA | No | 313 | 236 | 30 |
| 10 | 33% SP | Yes | 2,081 | 1,897 | 30 |
| 11 | 33% SP | No | 1,709 | 1,415 | 30 |

The results indicate that irradiation of the films increases peak and average bond strength when compared to films that included the same coating and that were not irradiated. For example, the peak and average bond strengths of Example 1 are more than 100% greater than the peak and average bond strengths of Example 6, which included the same coating but was not irradiated. Examples 1, 2, 3, 4, and 10 are the irradiated versions of Examples 6, 7, 8, 9, and 11, respectively. The percent increase of the effect of irradiation on the peak and average bond strengths are reported in TABLE 2.

TABLE 2

| | Coating | | Increase in | Increase in |
|---|---|---|---|---|
| Example | (% Solids | | Peak Bond | Average Bond |
| Film | and Material) | Irradiated | Strength (%) | Strength (%) |
| 1 | 1% EAA | Yes | 114% | 154% |
| 6 | 1% EAA | No | | |
| 2 | 2% EAA | Yes | 75% | 117% |
| 7 | 2% EAA | No | | |
| 3 | 4% EAA | Yes | 300% | 1,475% |
| 8 | 4% EAA | No | | |
| 4 | 8% EAA | Yes | 495% | 600% |
| 9 | 8% EAA | No | | |
| 10 | 33% SP | Yes | 22% | 34% |
| 11 | 33% SP | No | | |

With reference to TABLE 1, the effect of irradiation on the separation time of the films generally was the same as films that were not irradiated. Examples 4 and 9 differed from this general trend. Example 4 included an 8% solids water dispersible EAA coating, was irradiated, and included a separation time of 90 minutes. Example 9 included an 8% solids water dispersible coating, was not irradiated, and had a separation time of 30 minutes that was 66% less than the separation time of Example 4. Separation times of Examples 1-3, Examples 6-8, and Examples 10-11 were unaffected by irradiation.

The above description and examples illustrate certain embodiments of the present disclosure and are not to be interpreted as limiting. Selection of particular embodiments, combinations thereof, modifications, and adaptations of the various embodiments, conditions and parameters normally encountered in the art will be apparent to those skilled in the art and are deemed to be within the spirit and scope of the present invention.

1. A multilayer packaging film having a first surface and a second surface, the multilayer packaging film comprising:
a primer layer comprising a coating comprising a water dispersible material;
a first film connected to the primer layer, the first film comprising a first polymer and having a first surface, and a second surface; and
a second film connected to the primer layer, the second film comprising a barrier layer comprising a barrier material and having a first surface and a second surface;
wherein the primer layer is positioned between the first film second surface and the second film first surface.

2. The multilayer packaging film of claim 1, wherein the first film, the second film, or both of the first film and the second film being directly connected to the primer layer.

3. The multilayer packaging film of claim 1, wherein the first film first surface forms the multilayer packaging film first surface.

4. The multilayer packaging film of claim 1, wherein the second film second surface forms the multilayer packaging film second surface.

5. The multilayer packaging film of claim 1, further comprising an average bond strength of 20 grams/25.4 millimeter (g/25.4 mm) or greater between the first film second surface and the second film first surface according to ASTM F 904-98 (Reapproved 2003).

6. The multilayer packaging film of claim 1, wherein the water dispersible material comprises an acidic moiety.

7. The multilayer packaging film of claim 1, wherein the water dispersible material comprises a water dispersible sulfopolyester.

8. The multilayer packaging film of claim 1, wherein the primer layer comprises a thickness in a range of from greater than 0% to 20% of the thickness of the multilayer packaging film.

9. The multilayer packaging film according to claim 1, wherein the average density of the second film is less than the average density of the first film.

10. The multilayer packaging layer according to claim 1, wherein the barrier material comprises high density polyethylene (HDPE).

11. The multilayer packaging film according to claim 1, wherein the barrier material comprises ethylene vinyl alcohol copolymer (EVOH).

12. The multilayer packaging film according to claim 1, wherein the first film is an extrusion coated film.

13. The multilayer packaging film according to claim 1, wherein the first film comprises a multilayer film.

14. The multilayer packaging film according to claim 1, wherein the second film is a coextruded film.

15. The multilayer packaging film according to claim 1, wherein the first film comprises the first polymer comprising a single polymer in an amount in a range of from 90% to 100% of the single polymer by weight.

16. The multilayer packaging film according to claim 1, further comprising an irradiated multilayer film having a 20% or greater increase in average bond strength according to ASTM F 904-98 (Reapproved 2003).

17. A package comprising the multilayer packaging film according to claim 1.

18. A method of making a multilayer packaging film having a first surface and a second surface, the method comprising:
forming a first film comprising a first polymer and having a first surface and a second surface;
forming a second film comprising a barrier layer comprising a barrier material and having a first surface and a second surface;
coating the first film second surface, the second film first surface, or a combination thereof, with a water dispersible coating comprising a water dispersible material in a range of from 1% to 50% by weight of the water dispersible coating in a wet state;
drying the water dispersible coating from the wet state to form a primer layer, the primer layer connecting to the first film second surface, the second film first surface, or a combination thereof, respective to the coating operation; and
laminating the first film to the second film and the primer layer being positioned between the first film and the second film; and
wherein the primer layer comprises a thickness comprising a range of from greater than 0% to 20% of the thickness of the multilayer packaging film.

19. A method of making a multilayer packaging film having a first surface and a second surface, the method comprising:
forming a second film comprising a barrier layer comprising a barrier material and having a first surface and a second surface;
coating the second film first surface with a water dispersible coating comprising water dispersible material in a range of from 1% to 50% by weight of the water dispersible coating in a wet state;
drying the water dispersible coating from the wet state to form a primer layer and the primer layer connected to the second film; and
forming a first film comprising a first polymer and having a first surface and a second surface by extrusion coating the first film second surface to connect with the primer layer; and
wherein the primer layer comprises a thickness comprising a range of from greater than 0% to 20% of the thickness of the multilayer packaging film.

20. The method according claim 19, further comprising an irradiating operation comprising irradiating the multilayer packaging film.
